(19) United States
(12) Patent Application Publication
(10) Pub. No.: US 2020/0364774 A1
(43) Pub. Date: Nov. 19, 2020

(54) METHODS AND SYSTEMS FOR FACILITATING AN ONLINE SHOPPING EXPERIENCE BASED ON A GAME

(71) Applicant: Kazuyuki Nagashima, El Segundo, CA (US)

(72) Inventor: Kazuyuki Nagashima, El Segundo, CA (US)

(21) Appl. No.: 16/574,472

(22) Filed: Sep. 18, 2019

Related U.S. Application Data
(60) Provisional application No. 62/847,063, filed on May 13, 2019.

(51) Int. Cl. G06Q 30/06; G06Q 20/36

(52) U.S. Cl. CPC G06Q 30/0641; G06Q 20/367

(57) ABSTRACT

Disclosed is a method to facilitate an online shopping experience based on a game. The method includes receiving an amount from a user device, generating at least one token based on the amount, transmitting the at least one token to the user device, receiving at least one request from the user device, transmitting a vending machine interface to the user device, receiving at least one pull event from the user device based on the at least one token, generating at least one voucher based on the at least one pull event, transmitting the at least one voucher to the user device, transmitting at least one online store interface to the user device, receiving at least one shopping request from the user device, receiving the at least one voucher associated with the multiple points, from the user device and analyzing the at least one voucher to obtain at least one chip.

### FIELD OF THE INVENTION

Generally, the present disclosure relates to the field of data processing. More specifically, the present disclosure relates to methods and systems for facilitating an online shopping experience based on a game.

### BACKGROUND

A Gashapon (word made from Japanese words “Gacha” and “pon”) refers to a variety of vending machines configured to dispense capsule toys (i.e. toys packed with a capsule packaging) to consumers after money or specially designed card is inserted into the vending machine. Such vending machines (Gashapon) are widely popular in Japan and elsewhere. Further, such vending machines dispense toys randomly. For instance, one vending machine may only be configured to randomly dispense either of the four types of action figure toys (e.g. one Spiderman figure, one Batman figure, one Superman figure, and one ironman figure) when a user may insert a token (such as money) inside the machine. Further, it is unlikely that the user may get the toy of his/her own choice. However, the conventional Gacha based system is similar to the conventional shopping experience. The users may not find the conventional Gacha based system engaging. This may lead to a drop in sales via the conventional Gacha based system.

Therefore, there is a need for improved methods, systems, apparatuses, and devices for facilitating a shopping experience that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some aspects, is a method to facilitate an online shopping experience based on a game is disclosed. The method may include receiving, using a communication device, an amount from at least one user device. Further, the at least one user device is associated with at least one user. Further, the method may include generating, using a processing device, at least one token based on the amount. Further, the method may include transmitting, using the communication device, the at least one token to the at least one user device. Further, the method may include receiving, using the communication device, at least one request from the at least one user device. Further, the at least one request comprises a first request to access a vending machine interface. Further, the vending machine interface is associated with a vending machine. Further, the method may include transmitting, using the communication device, the vending machine interface to the at least one user device. Further, the method may include receiving, using the communication device, at least one pull event from the at least one user device based on the at least one token. Further, the method may include generating, using the communication device, at least one voucher based on the at least one pull event. Further, the at least one voucher is associated with a plurality of points. Further, the method may include transmitting, using the communication device, the at least one voucher to the user device. Further, the method may include transmitting, using the communication device, at least one online store interface to the at least one user device. Further, the at least one online store interface is associated with at least one online store. Further, the method may include receiving, using the communication device, at least one shopping request from the at least one user device. Further, the at least one shopping request comprises a second request to purchase at least one product. Further, the method may include receiving, using the communication device, the at least one voucher associated with the plurality of points, from the at least one user device. Further, the method may include analyzing, using the processing device, the at least one voucher to obtain at least one chip. Further, the at least one chip is associated with the at least one online store. Further, the at least one chip is redeemable for the at least one shopping request.

According to some aspects, a method to facilitate an online shopping experience based on a game. The method may include receiving, using a communication device, an amount from at least one user device. Further, the at least one user device is associated with at least one user. Further, the amount is a valid amount in real currency. The method may include generating, using a processing device, at least one token based on the amount. The method may include transmitting, using the communication device, the at least one token to the at least one user device. The method may include receiving, using the communication device, at least one request from the at least one user device. Further, the at least one request comprises a first request to access a vending machine interface. Further, the vending machine interface is associated with a vending machine. The method may include transmitting, using the communication device, the vending machine interface to the at least one user device. The method may include receiving, using the communication device, at least one pull event from the at least one user device based on the at least one token. The method may include generating, using the communication device, at least one voucher based on the at least one pull event. Further, the at least one voucher is associated with a plurality of points. Further, the at least one voucher is associated with at least one online store. Further, the at least one voucher is redeemable in the at least one online store. The method may include transmitting, using the communication device, the at least one voucher to the user device. The method may include transmitting, using the communication device, at least one online store interface to the at least one user device. Further, the at least one online store interface is associated with the at least one online store. The method may include receiving, using the communication device, at least one shopping request from the at least one user device. Further, the at least one shopping request comprises a second request to purchase at least one product. The method may include receiving, using the communication device, the at least one voucher associated with the plurality of points, from the at least one user device. The method may include analyzing, using the processing device, the at least one voucher to obtain at least one chip. Further, the at least one chip is associated with the at least one online store. Further, the at least one online store comprises the at least one product. Further, the at least one chip is redeemable for purchasing the at least one product based on the at least one shopping request.

According to some aspects, a system to facilitate an online shopping experience based on a game. The system may include a communication device and a processing device. The communication device may be configured for receiving an amount from at least one user device, wherein the at least one user device is associated with at least one user. Further, the communication device may be configured for transmitting at least one token to the at least one user device. Further, the communication device may be configured for receiving at least one request from the at least one user device, wherein the at least one request comprises a first request to access a vending machine interface, wherein the vending machine interface is associated with a vending machine. Further, the communication device may be configured for transmitting the vending machine interface to the at least one user device. Further, the communication device may be configured for receiving at least one pull event from the at least one user device based on the at least one token. Further, the communication device may be configured for transmitting at least one voucher to the user device. Further, the communication device may be configured for transmitting at least one online store interface to the at least one user device, wherein the at least one online store interface is associated with at least one online store. Further, the communication device may be configured for receiving at least one shopping request from the at least one user device, wherein the at least one shopping request comprises a second request to purchase at least one product. Further, the communication device may be configured for receiving the at least one voucher associated with a plurality of points, from the at least one user device. Further, the processing device may be configured for generating the at least one token based on the amount. Further, the processing device may be configured for generating the at least one voucher based on the at least one pull event, wherein the at least one voucher is associated with the plurality of points. Further, the processing device may be configured for analyzing the at least one voucher to obtain at least one chip, wherein the at least one chip is associated with the at least one online store, wherein the at least one chip is redeemable for the at least one shopping request.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system to facilitate an online shopping experience based on a game in accordance with some embodiments.

FIG. 3 is a block diagram of a system to facilitate an online shopping experience based on a game in accordance with some embodiments.

FIG. 4 is a flowchart of a method to facilitate an online shopping experience based on a game in accordance with some embodiments.

FIG. 5 is a flowchart of a method to facilitate an online shopping experience based on a game in accordance with some embodiments.

FIG. 6 is a flowchart of a method for facilitating physical shopping experience using Gacha Chips, in accordance with some embodiments.

FIG. 7 is a flowchart of a method to facilitate online shopping experience using Gacha Chips, in accordance with some embodiments.

FIG. 8 is an exemplary flowchart of a method to facilitate physical shopping experience using Gacha Chips, in accordance with some exemplary embodiments.

FIG. 9 is an exemplary flowchart of a method to facilitate online shopping experience using Gacha Chips, in accordance with some exemplary embodiments.

FIG. 10 is an exemplary representation of a Gacha Token, in accordance with some embodiments.

FIG. 11 is an exemplary representation of a Gacha Voucher, in accordance with some embodiments.

FIG. 12 is an exemplary representation of Gacha Chips, in accordance with some embodiments.

FIG. 13 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

The present disclosure includes many aspects and features. Moreover, while many aspects and features relate to, and are described in the context of online shopping experience, embodiments of the present disclosure are not limited to use only in this context.

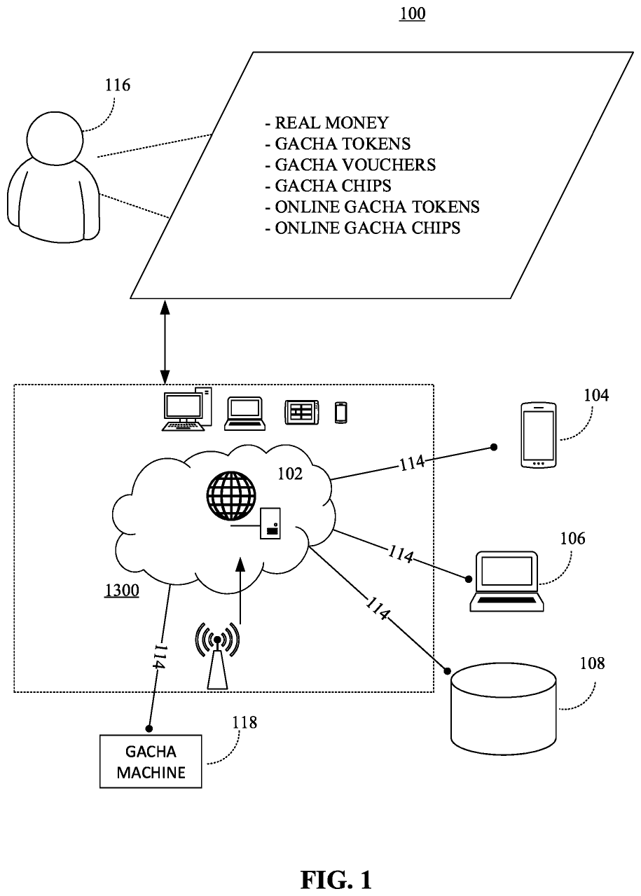

FIG. 1 is an illustration of an online platform 100 consistent with various embodiments of the present disclosure. By way of non-limiting example, the online platform 100 to facilitate an online shopping experience based on a game may be hosted on a centralized server 102, such as, for example, a cloud computing service. The centralized server 102 may communicate with other network entities, such as, for example, a mobile device 104 (such as a smartphone, a laptop, a tablet computer, etc.), other electronic devices 106 (such as desktop computers, server computers, etc.), databases 108 and a Gacha Machine 118 over a communication network 114, such as, but not limited to, the Internet. Further, users of the online platform 100 may include relevant parties such as, but not limited to, buyers, sellers, administrators, service providers, service consumers and so on. Accordingly, in some instances, electronic devices operated by the one or more relevant parties may be in communication with the platform 100.

A user 116, such as the one or more relevant parties, may access the online platform 100 through a web-based software application or browser. The web-based software application may be embodied as, for example, but not be limited to, a website, a web application, a desktop application, and a mobile application compatible with a computing device 1300.

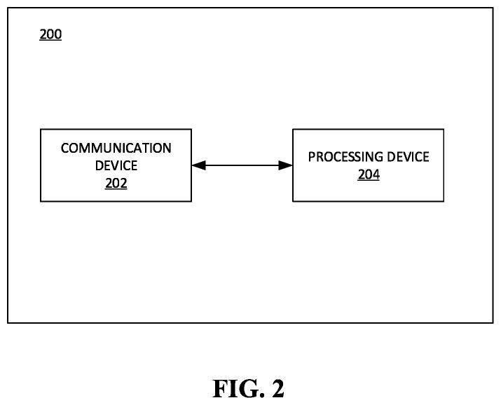

FIG. 2 is a block diagram of a system 200 to facilitate an online shopping experience based on a game in accordance with some embodiments. Further, the system 200 may include a communication device 202 and a processing device 204.

Further, the communication device 202 may be configured for receiving an amount from at least one user device (such as a mobile device 104 and other electronic devices 106). Further, the at least one user device may be associated with at least one user (such as the user 116). Further, the amount may be a valid amount in real currency. In some embodiments, the amount may be associated with at least one digital wallet. In some embodiments, the digital wallet may be configured to provide the amount, wherein the digital wallet may be associated with the at least one user.

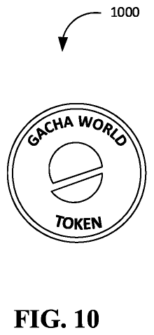

Further, the communication device 202 may be configured for transmitting at least one token to the at least one user device. In some embodiments, each token of the at least one token may be associated with a fixed amount. Further, the amount may include the fixed amount. FIG. 10 is an exemplary representation of a token, in accordance with some embodiments.

Further, the communication device 202 may be configured for receiving at least one request from the at least one user device. Further, the at least one request may include a first request to access a vending machine interface. Further, the vending machine interface may be associated with a vending machine.

Further, the communication device 202 may be configured for transmitting the vending machine interface to the at least one user device. In some embodiments, the vending machine may include at least one interactive display panel. Further, the at least one interactive display panel displays the vending machine interface to the at least one user. In an embodiment, the vending machine may be the Gacha Machine 118. Further, the vending machine may be remotely located. Alternatively, the vending machine may be a software application running on a remote server (such as the server 102).

Further, the communication device 202 may be configured for receiving at least one pull event from the at least one user device based on the at least one token. The at least one pull event may include a user perform an action on the at least one user device. For example, the user may perform one or more of a flicking action, a touching action, a pressing action on the screen of the at least one user device. Further, the user may be required to perform an action for each token.

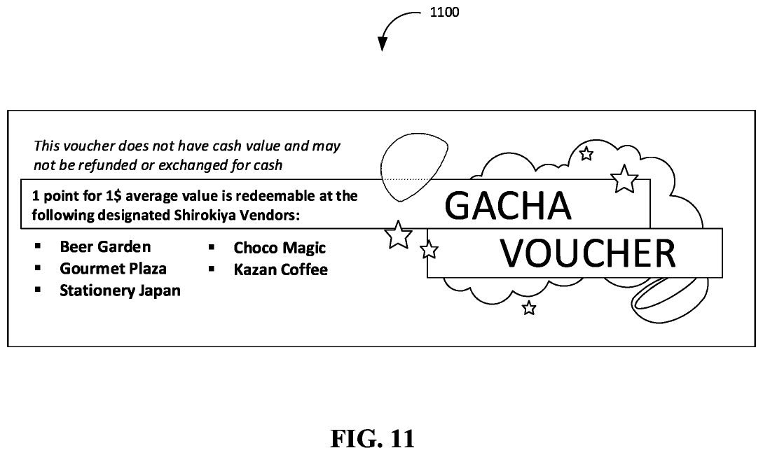

Further, the communication device 202 may be configured for transmitting at least one voucher to the user device. In some embodiments, the at least one voucher may be associated with the at least one online store. Further, the at least one voucher may be redeemable in the at least one online store. FIG. 11 is an exemplary representation of a voucher, in accordance with some embodiments.

Further, the communication device 202 may be configured for transmitting at least one online store interface to the at least one user device. Further, the at least one online store interface may be associated with at least one online store.

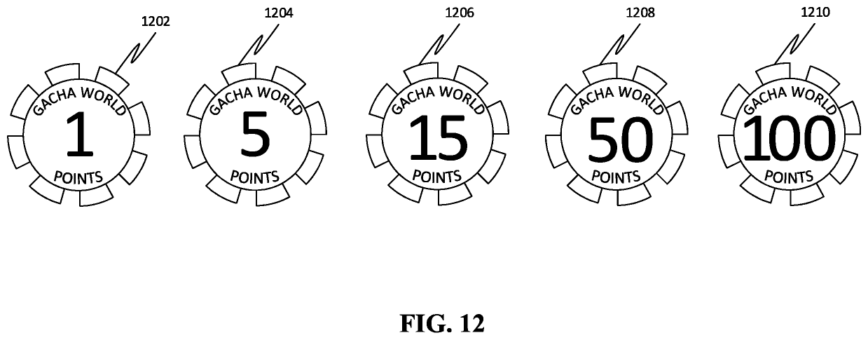

In some embodiments, the at least one online store may include the at least one product, wherein the at least one product may be purchased using the at least one chip, wherein the at least one product may be purchased based on the at least one shopping request. FIG. 12 is an exemplary representation of the at least one chip, in accordance with some embodiments.

Further, the communication device 202 may be configured for receiving at least one shopping request from the at least one user device. Further, the at least one shopping request may include a second request to purchase at least one product.

Further, the communication device 202 may be configured for receiving the at least one voucher associated with a plurality of points, from the at least one user device. Further, the plurality of points may determine a denomination of the corresponding voucher. In some embodiments, the plurality of points may be associated with the at least one voucher may be assigned randomly. Further, the plurality of points may include an upper point limit and a lower point limit. Therefore, the denomination of the at least one voucher may vary randomly in a range between the upper point limit and the lower point limit.

Further, the processing device 204 may be configured for generating the at least one token based on the amount. Further, the processing device 204 may be configured for generating the at least one voucher based on the at least one pull event. Further, the at least one voucher may be associated with the plurality of points.

Further, the processing device 204 may be configured for analyzing the at least one voucher to obtain at least one chip, wherein the at least one chip may be associated with the at least one online store, wherein the at least one chip may be redeemable for the at least one shopping request. Further, the number/value of the at least one chip may depend on the denomination of the at least one voucher.

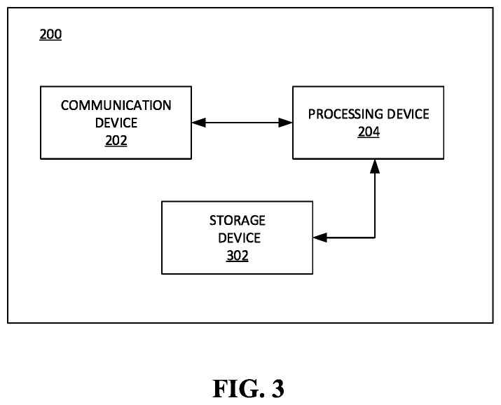

In further embodiments, the system 200 may include a storage device 302 (shown in FIG. 3) configured for receiving the amount from a database (such as a database in the databases 108). Further, the storage device 302 may be communicatively coupled with the processing device 204.

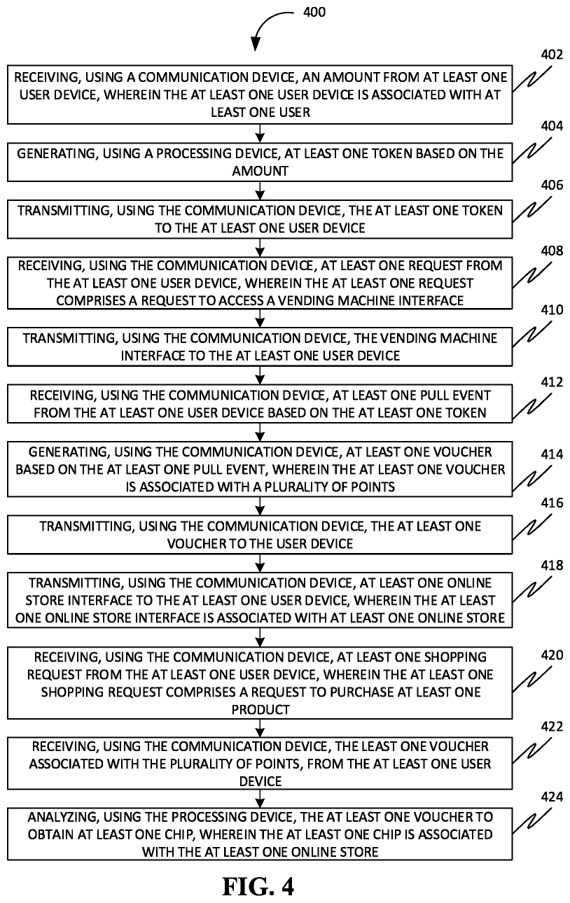

FIG. 4 is a flowchart of a method 400 to facilitate an online shopping experience based on a game in accordance with some embodiments. At 402, the method may include receiving, using a communication device (such as the communication device 202), an amount from at least one user device, wherein the at least one user device may be associated with at least one user. In some embodiments, the amount may be a valid amount in real currency. In some embodiments, the amount may be associated with at least one digital wallet, wherein the digital wallet may be configured to provide the amount, wherein the digital wallet may be associated with the at least one user.

Further, at 404, the method 400 may include generating, using a processing device (such as the processing device 204), at least one token based on the amount. In some embodiments, each token of the at least one token may be associated with a fixed amount, wherein the amount may include the fixed amount.

Further, at 406, the method 400 may include transmitting, using the communication device, the at least one token to the at least one user device.

Further, at 408, the method 400 may include receiving, using the communication device, at least one request from the at least one user device. Further, the at least one request may include a first request to access a vending machine interface, wherein the vending machine interface may be associated with a vending machine.

Further, at 410, the method 400 may include transmitting, using the communication device, the vending machine interface to the at least one user device.

In some embodiments, the vending machine may include at least one interactive display panel. Further, the at least one interactive display panel may display the vending machine interface to the at least one user.

Further, at 412, the method 400 may include receiving, using the communication device, at least one pull event from the at least one user device based on the at least one token.

Further, at 414, the method 400 may include generating, using the communication device, at least one voucher based on the at least one pull event. Further the at least one voucher may be associated with a plurality of points. In some embodiments, the at least one voucher may be associated with at least one online store. Further, the at least one voucher may be redeemable in the at least one online store.

In some embodiments, the plurality of points associated with the at least one voucher is assigned randomly. Further, the plurality of points may include an upper point limit and a lower point limit.

In some embodiments, the at least one online store may include the at least one product. Further, the at least one product may be purchased using the at least one chip. Further, the at least one product may be purchased based on the at least one shopping request.

Further, at 416, the method 400 may include transmitting, using the communication device, the at least one voucher to the user device.

Further, at 418, the method 400 may include transmitting, using the communication device, at least one online store interface to the at least one user device, wherein the at least one online store interface may be associated with at least one online store.

Further, at 420, the method 400 may include receiving, using the communication device, at least one shopping request from the at least one user device, wherein the at least one shopping request may include a second request to purchase at least one product.

Further, at 422, the method 400 may include receiving, using the communication device, the at least one voucher associated with the plurality of points, from the at least one user device. and

Further, at 424, the method 400 may include analyzing, using the processing device, the at least one voucher to obtain at least one chip, wherein the at least one chip may be associated with the at least one online store, wherein the at least one chip may be redeemable for the at least one shopping request.

In further embodiments, the method 400 may include receiving, using a storage device (such as the storage device 302), the amount from a database (such as a database in the databases 108). Further, the storage device may be communicatively coupled with the processing device.

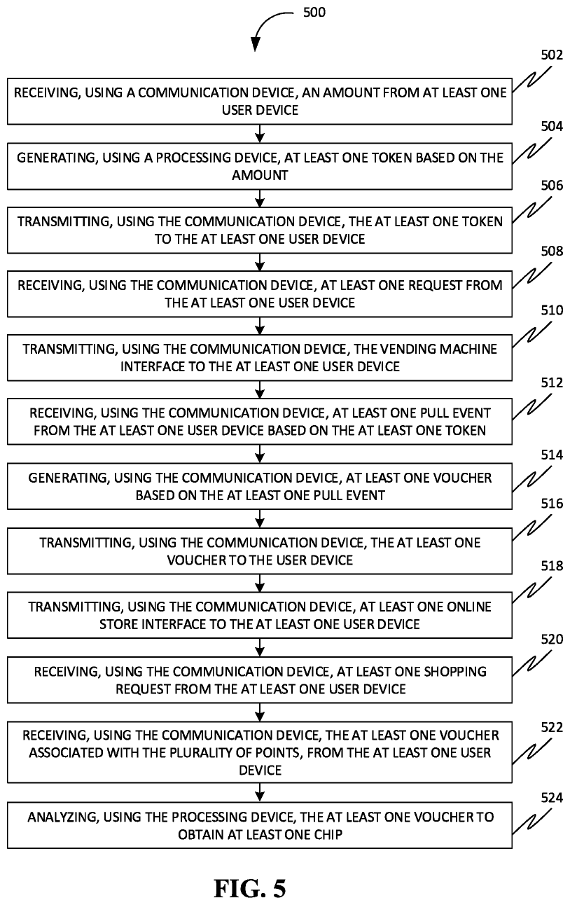

FIG. 5 is a flowchart of a method 500 to facilitate an online shopping experience based on a game in accordance with some embodiments. At 502, the method 500 may include receiving, using a communication device (such as the communication device 202), an amount from at least one user device, wherein the at least one user device may be associated with at least one user. Further, the amount may be a valid amount in real currency.

Further, at 504, the method 500 may include generating, using a processing device (such as the processing device 204), at least one token based on the amount.

Further, at 506, the method 500 may include transmitting, using the communication device, the at least one token to the at least one user device.

Further, at 508, the method 500 may include receiving, using the communication device, at least one request from the at least one user device. Further, the at least one request may include a first request to access a vending machine interface, wherein the vending machine interface may be associated with a vending machine.

Further, at 510, the method 500 may include transmitting, using the communication device, the vending machine interface to the at least one user device.

Further, at 512, the method 500 may include receiving, using the communication device, at least one pull event from the at least one user device based on the at least one token.

Further, at 514, the method 500 may include generating, using the communication device, at least one voucher based on the at least one pull event, wherein the at least one voucher may be associated with a plurality of points. Further, the at least one voucher may be associated with at least one online store, wherein the at least one voucher may be redeemable in the at least one online store.

Further, at 516, the method 500 may include transmitting, using the communication device, the at least one voucher to the user device.

Further, at 518, the method 500 may include transmitting, using the communication device, at least one online store interface to the at least one user device, wherein the at least one online store interface may be associated with the at least one online store.

Further, at 520, the method 500 may include receiving, using the communication device, at least one shopping request from the at least one user device, wherein the at least one shopping request may include a second request to purchase at least one product.

Further, at 522, the method 500 may include receiving, using the communication device, the at least one voucher associated with the plurality of points, from the at least one user device.

Further, at 524, the method 500 may include analyzing, using the processing device, the at least one voucher to obtain at least one chip. Further, the at least one chip may be associated with the at least one online store, wherein the at least one online store may include the at least one product, wherein the at least one chip may be redeemable for purchasing the at least one product based on the at least one shopping request.

In some embodiments, the vending machine may include at least one interactive display panel, wherein the at least one interactive display panel may display the vending machine interface to the at least one user.

According to some embodiments, the present disclosure relates to a new shopping experience which focuses on gaming, rather than buying itself. The new shopping experience may be provided using tokens (may be called Gacha tokens), vouchers (may be called Gacha vouchers), and chips (may be called Gacha chips). Further, the present disclosure includes Gacha Shop (retail and online) configured to create the new shopping experience. All the infrastructure to support the new shopping experience may be called Gacha world.

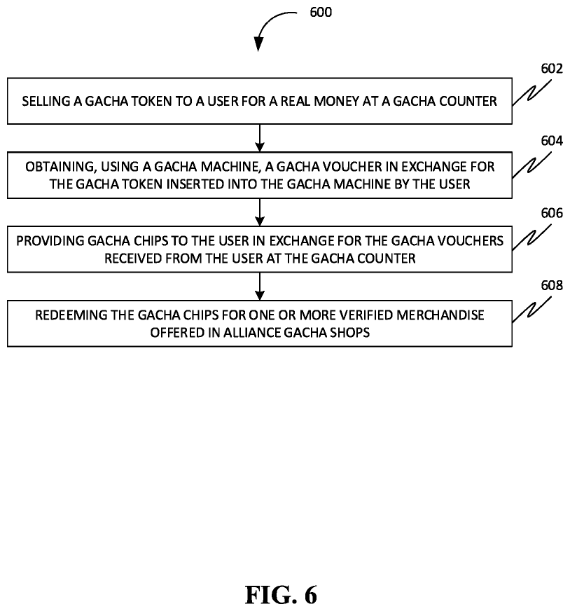

FIG. 6 is a flowchart of a method 600 for facilitating physical shopping experience using Gacha Chips, in accordance with some embodiments. Accordingly, at 602, the method 600 may include a step of selling a Gacha Token to a user for a real money at a Gacha counter. Further, the Gacha token, in an instance, may be specially designed physical tokens that may be inserted into vending machines (e.g. Gashapon and/or a Gacha machine) in order to get items out from the vending machine. For instance, as shown in FIG. 10, the Gacha token may be shaped like that of a coin with a standardized size, weight, and/or imprinted design. Further, the Gacha Tokens, in an instance, may be purchased by the user in exchange for the real money at the Gacha counter. For instance, the user may purchase one Gacha token for the real money, e.g., 5 US dollars at the Gacha counter. Further, the Gacha counter, in an instance, may be a physical counter (at a Gacha shop) that may be authorized to sell the Gacha tokens in exchange for real money.

Further, at 604, the method 600 may include a step of obtaining, using a Gacha machine, a Gacha voucher in exchange for the Gacha Token inserted into the Gacha machine by the user. For instance, once the user may purchase the Gacha Tokens from the Gacha counter, the user may insert the Gacha Token into the Gacha machine to operate the Gacha machine. Further, the Gacha machine, in an instance, may be a vending machine that may be configured to generate the Gacha vouchers to the user after the Gacha tokens may be inserted into the Gacha machine. Further, the Gacha vouchers, in an instance, may be coupons that may be assigned with a certain value. For instance, each Gacha voucher may be assigned with a value of either, e.g., 5 points, 10 points, 50 points, 100 points, 500 points, and 1,000 points. Further, the Gacha machine, in an instance, may be configured to randomly generate the Gacha voucher to the user, therefore the user may not know which Gacha voucher may be generated by the Gacha machine or may not know the value associated with the Gacha voucher beforehand. Further, in some embodiments, the Gacha voucher may be redeemed at selected vendors. Further, FIG. 11 shows an exemplary representation of a Gacha voucher 1100.

Further, at 606, the method 600 may include a step of providing Gacha chips to the user in exchange for the Gacha vouchers received from the user at the Gacha counter. Accordingly, the Gacha chips, in an instance, may be physical coins with an associated denomination. For instance, as shown in FIG. 12, each Gacha chip (in the Gacha chips 1202-1210) may be assigned with a denomination of either, e.g., 1 points, 5 points, 15 points, 50 points, and 100 points respectively. Further, the Gacha chip, in an instance, may be configured to be redeemed at any Alliance Gacha shop based on the denomination associated with the Gacha chip.

Further, at 608, the method 600 may include a step of redeeming the Gacha chip for one or more verified merchandise offered in Alliance Gacha shops. Further, the Alliance Gacha shops, in an instance, may be authorized facilities where the one or more verified merchandise may be offered in exchange for the Gacha chips. Further, the user, in an instance, may use the Gacha chips as a legal tender to purchase the one or more verified merchandise that may be offered at the Alliance Gacha shops. Further, the one or more verified merchandise, in an instance, may be any goods and/or services that may be offered at the Alliance Gacha shops. For instance, the one or more verified merchandise may include, but not limited to, toys (e.g. action figures, toy cars etc.), clothes, shoes, and so on. Further, each verified merchandise of the one or more verified merchandise, in an instance, may be configured to be purchased based on the denomination associated with the Gacha chips. For instance, if a verified merchandise (such as an action figure of Spiderman) may cost 100 points of the Gacha chip, then the user may use the Gacha chip with denomination of 100 points in order to purchase the verified merchandise.

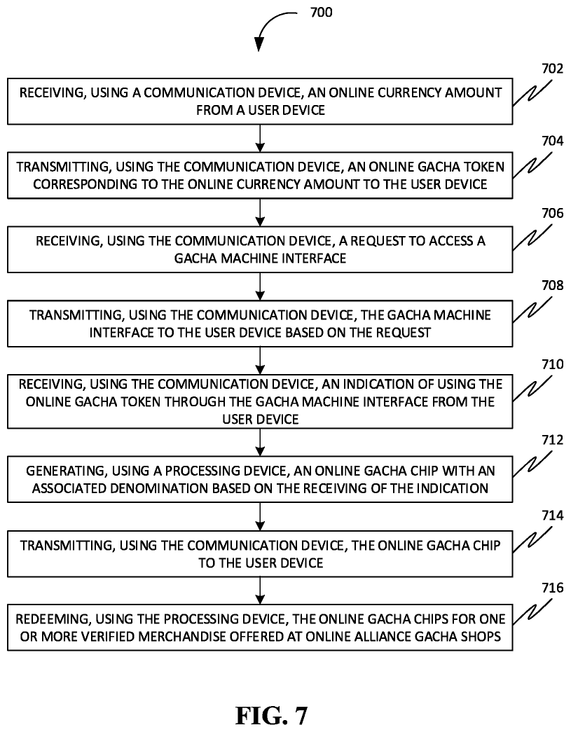

FIG. 7 is a flowchart of a method 700 to facilitate online shopping experience using Gacha Chips, in accordance with some embodiments. Accordingly, at 702, the method 700 may include a step of receiving, using a communication device (such as the communication device 202), an online currency amount from a user device. Further, the online currency amount, in an instance, may be a valid amount in real currency (e.g. in US dollars) that may be received from the user device such as, but not limited to, a smartphone, a laptop, a smartwatch, a Gacha machine, a PC, a tablet, and so on. Further, the online currency may be received from a digital wallet associated with the user device. Further, the digital wallet, in an instance, may be an electronic device and/or online service that may allow a user to make electronic transactions. Further, the digital wallet, in an instance, may be accessed by the user through an application on the user device. For instance, the digital wallet may include applications such as (but not limited to) Google pay, Amazon pay etc. Further, in some embodiments, the online currency may be received from a storage device associated with the user device. For instance, the storage device may be configured to store currency (e.g. cryptocurrency) in an encrypted form that may be accessed by the user through public/private keys. Further, in some embodiments, the online currency may be received from a bank account associated with the user device. For instance, the user may directly transfer the online currency amount by using an application interface provided by a bank associated with the user.

Further, at 704, the method 700 may include a step of transmitting, using the communication device, an online Gacha token corresponding to the online currency amount to the user device. Accordingly, the online Gacha token, in an instance, may be an electronic token that may allow the user to use a vending machine (e.g. Gashapon and/or a Gacha machine) online. Further, the online Gacha Tokens, in an instance, may be purchased by the user in exchange for the online currency amount at the online platform 100. For instance, the user may purchase one online Gacha token for the online currency amount of, e.g., 5 US dollars by interacting with the user device.

Further, at 706, the method 700 may include a step of receiving, using the communication device, a request to access a Gacha machine interface. Accordingly, the user, in an instance, may interact with the user device to request (and/or communicate with) the online platform 100 that may be configured to provide the Gacha machine interface to the user. For instance, the user may visit a certain website associated with the Gacha world through the user device (e.g. a laptop) in order to request an access for the Gacha machine interface. Further, in another instance, a Gacha machine (such as the Gacha machine 118) may include a display panel that may allow the user to interact in order to request the access for the Gacha machine interface.

Further, at 708, the method 700 may include a step of transmitting, using the communication device, the Gacha machine interface to the user device based on the request. Accordingly, the online platform 100, in an instance, may be configured to transmit the Gacha machine interface to the user device through a wireless transmitter. The wireless transmitter, in an instance, may transmit the Gacha machine interface over, but not limited to, a Wi-Fi, a Bluetooth, an electromagnetic waveform, ultra-sound, cellular (5G) and/or an Infra-red etc. Further, the Gacha machine interface, in an instance, may include a virtual representation of the Gacha machine (and/or may be referred to as virtual Gacha machine) where the user may be allowed to provide the online Gacha tokens in order to operate the virtual Gacha machine.

Further, at 710, the method 700 may include a step of receiving, using the communication device, an indication of using the online Gacha token through the Gacha machine interface from the user device. Accordingly, the Gacha machine interface, in an instance, may include a section that may allow the user to provide the indication of using the online Gacha token. For instance, the user may tap on a section, e.g., “Gacha machine Pull” section that may be available on the Gacha machine interface.

Further, at 712, the method 700 may include a step of generating, using a processing device processing, an online Gacha chip with an associated denomination based on the receiving of the indication. For instance, once the user may provide the indication of using the online Gacha token through the Gacha machine interface in order to operate the virtual Gacha machine, the online platform 100 may generate the online Gacha chip and/or may assign (randomly) a denomination. Further, the online Gacha chips, in an instance, may be online coins with the associated denomination. For instance, as shown in FIG. 12, each online Gacha chip (in the Gacha chips 1202-1210) may be assigned with a denomination of either, e.g., 1 points, 5 points, 15 points, 50 points, and 100 points respectively. Further, the online Gacha chip, in an instance, may be configured to be redeemed at any online Alliance Gacha shop based on the denomination associated with the online Gacha chip.

Further, at 714, the method 700 may include a step of transmitting, using the communication device, the online Gacha chip to the user device. Accordingly, the online platform 100, in an instance, may be configured to transmit the online Gacha chips to the user device through a wireless transmitter. The wireless transmitter, in an instance, may transmit the online Gacha chips over, but not limited to, a Wi-Fi, a Bluetooth, an electromagnetic waveform, ultra-sound, cellular (5G) and/or an Infra-red etc.

Further, at 716, the method 700 may include a step of redeeming, using the processing device, the online Gacha chips for one or more verified merchandise offered at online Alliance Gacha shops.

Further, the online Alliance Gacha shops, in an instance, may be any authorized online facility where the one or more verified merchandise may be offered in exchange for the online Gacha chips. Further, the user, in an instance, may use the online Gacha chips as a legal tender to purchase the one or more verified merchandise that may be offered at the online Alliance Gacha shops. Further, the one or more verified merchandise, in an instance, may be any goods and/or services that may be offered at the online Alliance Gacha shops. For instance, the one or more verified merchandise may include, but not limited to, toys (e.g. action figures, toy cars etc.), clothes, shoes, and so on. Further, each verified merchandise of the one or more verified merchandise, in an instance, may be configured to be purchased online based on the denomination associated with the online Gacha chips. For instance, if a verified merchandise (such as an action figure of Spiderman) may cost 100 points of the online Gacha chip, then the user may interact with the user device to use the online Gacha chip with denomination of 100 points in order to purchase the verified merchandise.

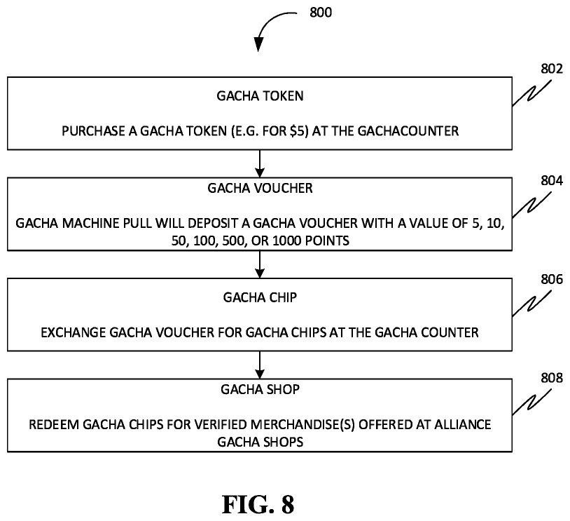

FIG. 8 is an exemplary flowchart of a method 800 to facilitate physical shopping experience using Gacha Chips, in accordance with some exemplary embodiments. Accordingly, at 802, the method 800 may include purchasing a Gacha Token (e.g. for 5) at the Gacha Counter. Further, at 804, the method 800 may include Gacha Machine pull that may deposit a Gacha Voucher with a value of 5, 10, 50, 100, 500 or 1,000 Points. Further, at 806, the method 800 may include exchanging Gacha Voucher for Gacha Chips at the Gacha Counter. Further, at 808, the method 800 may include Redeeming Gacha Chips for verified merchandise(s) offered at Alliance Gacha Shops.

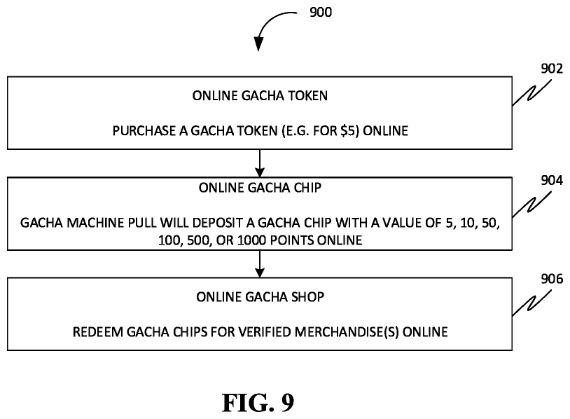

FIG. 9 is an exemplary flowchart of a method 900 to facilitate online shopping experience using Gacha Chips, in accordance with some exemplary embodiments. Accordingly, at 902, the method 900 may include purchasing a Gacha Token (e.g. for 5) online. Further, at 904, the method 900 may include Gacha Machine pull that may deposit a Gacha Chip with a value of 5, 10, 50, 100, 500 or 1,000 Points online. Further, at 906, the method 900 may include redeeming Gacha Chips for verified merchandise(s) online.

FIG. 10 is an exemplary representation of a Gacha Token 1000, in accordance with some embodiments.

FIG. 11 is an exemplary representation of a Gacha Voucher 1100, in accordance with some embodiments.

FIG. 12 is an exemplary representation of Gacha Chips 1202-1210, in accordance with some embodiments.

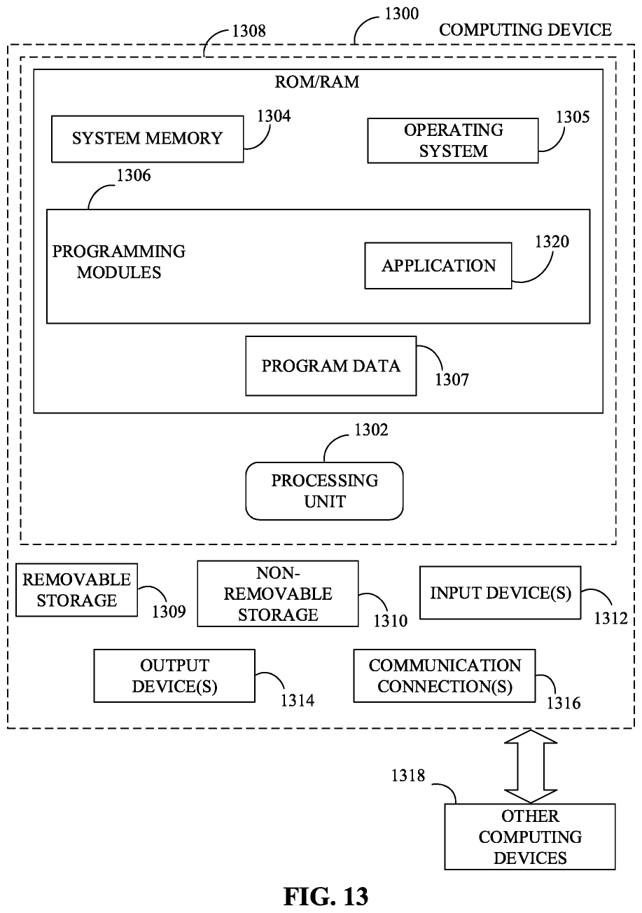

With reference to FIG. 13, a system consistent with an embodiment of the disclosure may include a computing device or cloud service, such as computing device 1300. In a basic configuration, computing device 1300 may include at least one processing unit 1302 and a system memory 1304. Depending on the configuration and type of computing device, system memory 1304 may comprise, but is not limited to, volatile (e.g. random-access memory (RAM)), non-volatile (e.g. read-only memory (ROM)), flash memory, or any combination. System memory 1304 may include operating system 1305, one or more programming modules 1306, and may include a program data 1307. Operating system 1305, for example, may be suitable for controlling computing device 1300's operation. In one embodiment, programming modules 1306 may include image-processing module, machine learning module. Furthermore, embodiments of the disclosure may be practiced in conjunction with a graphics library, other operating systems, or any other application program and is not limited to any particular application or system. This basic configuration is illustrated in FIG. 13 by those components within a dashed line 1308.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by a removable storage 1309 and a non-removable storage 1310. Computer storage media may include volatile and non-volatile, removable and non-removable media implemented in any method or technology for storage of information, such as computer-readable instructions, data structures, program modules, or other data. System memory 1304, removable storage 1309, and non-removable storage 1310 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1300. Any such computer storage media may be part of device 1300. Computing device 1300 may also have input device(s) 1312 such as a keyboard, a mouse, a pen, a sound input device, a touch input device, a location sensor, a camera, a biometric sensor, etc. Output device(s) 1314 such as a display, speakers, a printer, etc. may also be included. The aforementioned devices are examples and others may be used.

Computing device 1300 may also contain a communication connection 1316 that may allow device 1300 to communicate with other computing devices 1318, such as over a network in a distributed computing environment, for example, an intranet or the Internet. Communication connection 1316 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1304, including operating system 1305. While executing on processing unit 1302, programming modules 1306 (e.g., application 1320 such as a media player) may perform processes including, for example, one or more stages of methods, algorithms, systems, applications, servers, databases as described above. The aforementioned process is an example, and processing unit 1302 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method to facilitate an online shopping experience based on a game, the method comprising:
receiving, using a communication device, an amount from at least one user device, wherein the at least one user device is associated with at least one user;
generating, using a processing device, at least one token based on the amount;
transmitting, using the communication device, the at least one token to the at least one user device;
receiving, using the communication device, at least one request from the at least one user device, wherein the at least one request comprises a first request to access a vending machine interface, wherein the vending machine interface is associated with a vending machine;
transmitting, using the communication device, the vending machine interface to the at least one user device;
receiving, using the communication device, at least one pull event from the at least one user device based on the at least one token;
generating, using the communication device, at least one voucher based on the at least one pull event, wherein the at least one voucher is associated with a plurality of points;
transmitting, using the communication device, the at least one voucher to the user device;
transmitting, using the communication device, at least one online store interface to the at least one user device, wherein the at least one online store interface is associated with at least one online store;
receiving, using the communication device, at least one shopping request from the at least one user device, wherein the at least one shopping request comprises a second request to purchase at least one product;
receiving, using the communication device, the at least one voucher associated with the plurality of points, from the at least one user device; and
analyzing, using the processing device, the at least one voucher to obtain at least one chip, wherein the at least one chip is associated with the at least one online store, wherein the at least one chip is redeemable for the at least one shopping request.

2. The method of claim 1, wherein the amount is a valid amount in real currency.

3. The method of claim 1, wherein the amount is associated with at least one digital wallet, wherein the digital wallet is configured to provide the amount, wherein the digital wallet is associated with the at least one user.

4. The method of claim 1, wherein each token of the at least one token is associated with a fixed amount.

5. The method of claim 1 further comprising receiving, using a storage device, the amount from a database, wherein the storage device is communicatively coupled with the processing device.

6. The method of claim 1, wherein the at least one voucher is associated with the at least one online store, wherein the at least one voucher is redeemable in the at least one online store.

7. The method of claim 1, wherein the plurality of points associated with the at least one voucher is assigned randomly, wherein the plurality of points comprises an upper point limit and a lower point limit.

8. The method of claim 1, wherein the at least one online store comprises the at least one product, wherein the at least one product is purchased using the at least one chip, wherein the at least one product is purchased based on the at least one shopping request.

9. The method of claim 1, wherein the vending machine comprises at least one interactive display panel, wherein the at least one interactive display panel displays the vending machine interface to the at least one user.

10. A method to facilitate an online shopping experience based on a game, the method comprising:
receiving, using a communication device, an amount from at least one user device, wherein the at least one user device is associated with at least one user, wherein the amount is a valid amount in real currency;
generating, using a processing device, at least one token based on the amount;
transmitting, using the communication device, the at least one token to the at least one user device;
receiving, using the communication device, at least one request from the at least one user device, wherein the at least one request comprises a first request to access a vending machine interface, wherein the vending machine interface is associated with a vending machine;
transmitting, using the communication device, the vending machine interface to the at least one user device;
receiving, using the communication device, at least one pull event from the at least one user device based on the at least one token;
generating, using the communication device, at least one voucher based on the at least one pull event, wherein the at least one voucher is associated with a plurality of points, wherein the at least one voucher is associated with at least one online store, wherein the at least one voucher is redeemable in the at least one online store;
transmitting, using the communication device, the at least one voucher to the user device;
transmitting, using the communication device, at least one online store interface to the at least one user device, wherein the at least one online store interface is associated with the at least one online store;
receiving, using the communication device, at least one shopping request from the at least one user device, wherein the at least one shopping request comprises a second request to purchase at least one product;
receiving, using the communication device, the at least one voucher associated with the plurality of points, from the at least one user device; and
analyzing, using the processing device, the at least one voucher to obtain at least one chip, wherein the at least one chip is associated with the at least one online store, wherein the at least one online store comprises the at least one product, wherein the at least one chip is redeemable for purchasing the at least one product based on the at least one shopping request.

11. The method of claim 10, wherein the vending machine comprises at least one interactive display panel, wherein the at least one interactive display panel displays the vending machine interface to the at least one user.

12. A system to facilitate an online shopping experience based on a game, the system comprising:
a communication device configured for:
receiving an amount from at least one user device, wherein the at least one user device is associated with at least one user;
transmitting at least one token to the at least one user device;
receiving at least one request from the at least one user device, wherein the at least one request comprises a first request to access a vending machine interface, wherein the vending machine interface is associated with a vending machine;
transmitting the vending machine interface to the at least one user device;
receiving at least one pull event from the at least one user device based on the at least one token;
transmitting at least one voucher to the user device;
transmitting at least one online store interface to the at least one user device, wherein the at least one online store interface is associated with at least one online store;
receiving at least one shopping request from the at least one user device, wherein the at least one shopping request comprises a second request to purchase at least one product;
receiving the at least one voucher associated with a plurality of points, from the at least one user device;
a processing device configured for:
generating the at least one token based on the amount;
generating the at least one voucher based on the at least one pull event, wherein the at least one voucher is associated with the plurality of points; and
analyzing the at least one voucher to obtain at least one chip, wherein the at least one chip is associated with the at least one online store, wherein the at least one chip is redeemable for the at least one shopping request.

13. The system of claim 12, wherein the amount is a valid amount in real currency.

14. The system of claim 12, wherein the amount is associated with at least one digital wallet, wherein the digital wallet is configured to provide the amount, wherein the digital wallet is associated with the at least one user.

15. The system of claim 12, wherein each token of the at least one token is associated with a fixed amount.

16. The system of claim 12 further comprising a storage device configured for receiving the amount from a database, wherein the storage device is communicatively coupled with the processing device.

17. The system of claim 12, wherein the at least one voucher is associated with the at least one online store, wherein the at least one voucher is redeemable in the at least one online store.

18. The system of claim 12, wherein the plurality of points associated with the at least one voucher is assigned randomly, wherein the plurality of points comprises an upper point limit and a lower point limit.

19. The system of claim 12, wherein the at least one online store comprises the at least one product, wherein the at least one product is purchased using the at least one chip, wherein the at least one product is purchased based on the at least one shopping request.

20. The system of claim 12, wherein the vending machine comprises at least one interactive display panel, wherein the at least one interactive display panel displays the vending machine interface to the at least one user.
